(19) United States
(12) Patent Application Publication
(10) Pub. No.: US 2011/0047025 A1
(43) Pub. Date: Feb. 24, 2011

(54) IMMEDIACY TARGETING IN ONLINE ADVERTISING

(75) Inventors: Ramazan Demir, Burbank, CA (US); Darshan V. Kantak, Pasadena, CA (US); Tarun Bhatia, Burbank, CA (US)

Correspondence Address: Mauriel Kapouytian & Treffert LLP, 151 First Avenue, #23, New York, NY, 10003, US

(73) Assignee: Yahoo! Inc., Sunnyvale, CA (US)

(21) Appl. No.: 12/546,194

(22) Filed: Aug. 24, 2009

(51) Int. Cl. G06Q 30/00

(52) U.S. Cl. 705/14.43; 705/14.54; 705/14.52

(57) ABSTRACT

Methods and systems are provided for advertising based at least in part on a temporal response profile associated with a user keyword query. Methods are provided in which the temporal response profile provides an indication of at least one time frame during which serving of advertisements, or certain advertisements, associated with the keyword query to the user is predicted to be more likely to be effective relative to times outside of the at least one time frame.

### BACKGROUND

Online advertisers naturally want to target the right audience with the right advertisements at the right times in order to optimize the performance of their advertising campaigns and maximize the return on their advertising spend. More so, in general, than offline advertising, online advertising can be targeted to users in many different ways for optimal performance.

Technological advancements make it possible to perform targeting with increasing accuracy and granularity. Furthermore, users and user activity, even at an individual user level, can often be tracked over time. In spite of this, however, particular advertisements are often not as well-suited as they might be to particular users at particular times.

There is a need for improved methods and systems for online advertising.

### SUMMARY

Some embodiments of the invention provide methods and systems for advertising based at least in part on a temporal response profile associated with user activity, such as a user keyword query. Methods are provided in which the temporal response profile provides an indication of at least one time frame during which serving of advertisements, or certain advertisements, associated with the keyword query to the user is predicted to be more likely to be effective relative to times outside of the at least one time frame.

### BRIEF DESCRIPTION OF THE DRAWINGS

FIG. 1 is a distributed computer system according to one embodiment of the invention;

FIG. 2 is a flow diagram of a method according to one embodiment of the invention;

FIG. 3 is a flow diagram of a method according to one embodiment of the invention;

FIG. 4 is a graphical representation of a keyword-dependent probability of conversion over time, according to one embodiment of the invention;

FIG. 5 is a block diagram representing targeting of advertising based on a state of a user in a buying cycle; and

FIG. 6 is a conceptual block diagram representing an advertisement selection, scheduling and serving system, incorporating immediacy targeting, according to one embodiment of the invention.

While the invention is described with reference to the above drawings, the drawings are intended to be illustrative, and the invention contemplates other embodiments within the spirit of the invention.

### DETAILED DESCRIPTION

With advances in technology, it is increasingly possible to target users with great accuracy and granularity. Ideally, as much information as possible should be brought to bear on advertising served to users, including the timing of such advertising, to maximize the performance of the advertisement and the associated advertising campaign. This, in turn, can lead to many advantages such as greater advertiser profit, greater advertiser involvement and spend, greater profit for advertisement facilitators, associated publishers, search engines, etc., as well a better user experience leading to more user involvement, conversions, etc.

Some embodiments of the invention increase advertisement performance by helping ensure that particular advertisements are a good or optimal match for a user in a particular stage of a cycle that may influence the user's intent or behavior, such as the user's phase in a particular buying cycle. Advertisements themselves may be associated with phases, such as phases in a selling cycle, which may map to or be associated with the buying cycle. Ensuring a good match at a time of serving of the advertisement, considering these factors, helps ensure that pertinent phases of the cycles are matched, which can provide better relevance and performance, such as higher probability of user click through, action, or conversion.

Increasingly, it is possible to track individual users over and through time, resources, media and applications. Furthermore, it is increasingly possible to obtain historical information, including very recent information, regarding a user's activity. In many instances, a user's state or phase at a given time with respect to one or more particular conditions, factors or cycles, for example, is very useful in optimally targeting the user with advertisements.

For example, a user's activity or conduct over time may allow determination or prediction with regard to a state of mind or intent of the user in some particular regard. This, in turn, may be significant in optimally selecting an advertisement to serve to the user. For example, a user's recent activity may allow determination or predication of a stage or phase of the user in some activity, process, cycle, etc. This phase can be used in selecting advertising that is appropriate or optimized for the user's phase, which can be in addition or in combination with a large variety of other targeting and forms of targeting.

For example, recent user activity may suggest a time lead-up to a particular user action, such as a conversion, which may be, for example, a purchase. For instance, a particular user action at a particular time, or a combination or series of such actions, may be used to suggest an better or ideal future time window for serving of a particular type or set of one or more advertisements to the user. Furthermore, such a time window may specifically relate to a particular phase of the user, as discussed above. Advertisements to be served at a particular time may be selected that are most appropriate for the phase of the user.

More complex extensions of this are of course possible. For example, recent user activity may be used to associate or map the user into a particular stage of a determined multi-stage cycle, and time windows may be associated with the cycle as well as elements of the cycle, such as individual stages thereof. Furthermore, a particular multi-stage cycle can be determined, modeled or represented in more complex fashions. For instance, functions can be used to indicate predicted probabilities over time, such as the probability that the user will be in a particular phase. Phases or time windows may be identified based on threshold predicted probabilities. A time window may be considered to exist anytime a particular time period is considered better than other times or time periods with regard to likely performance of one or more advertisements, or one or more groups or types of advertisements.

It should be noted that various aspects of embodiments of the invention include use of sophisticated matching techniques, probabilistic functions, predictions, and other determinations. Such determinations and predictions may be based on a variety of types of information, often including historical information associated with different users, advertisers, advertisement campaigns, etc. Generally, it is to be kept in mind that known machine learning, clustering, or aggregation techniques may be used in accordance with embodiments of the invention to make matches, correlations, associations, determinations, or predictions.

As used herein, a temporal response profile includes a set of information that at least provides or is used to provide an indication of at least one time frame during which serving of advertisements, or serving of a set of one or more advertisements, associated with user activity to the user is predicted or anticipated to be more likely to be effective relative to times outside of the at least one time frame.

For optimal performance, advertisements may be associated with particular user phases, as described herein. Furthermore, advertisements may themselves be determined or predicted to be most appropriate for particular stages or phases of other sorts. For example, just as user activity may be used to determine or identify phases of a user buying cycle, for instance, advertisements can be associated with phases of a determined selling cycle associated with a product, service, or content. In some embodiments, matching of advertisements with serving opportunities can include matching of a pertinent phase associated with an advertisement to a pertinent user buying cycle phase. Furthermore, any of various processes or methodologies, including functions, algorithms, etc. can be used for and in such matching.

Search re-targeting can be viewed as occurring anytime a user is targeted with an advertisement at some time after an event or activity that would initially suggest or lead to targeting the user with the advertisement, as opposed to immediately following the event or activity. For example, a user may enter a keyword search query, and may immediately then be served a set of advertisements, such as sponsored search advertisements. However, by tracking the user over time, media, applications, etc., later opportunities may occur to target the user with an advertisement based at least in part on the previously entered query. This may be particularly useful when opportunities for immediate serving of advertisements is limited. Search re-targeting, to the extent it is effective, can increase quality serving opportunities, and allow better and more use of advertising inventory. Embodiments of the invention can be used to improve the quality of search re-targeting.

Keyword queries are one type user activity or conduct that may be used in generating a temporal response profile associated with the user. In this context, a temporal response profile includes a set of information that at least provides, or can be used to provide, an indication of at least one time frame during which serving of advertisements, or serving of a set of one or more advertisements, associated with the keyword query to the user is predicted to be more likely to be effective relative to times outside of the at least one time frame.

Some embodiments of the invention associate keyword queries, or groups thereof, with a temporal value in connection with associated advertising. For example, particular keyword queries may lead to optimal associated advertisement performance over a particular length time window which may follow entry of the query. This time window may represent the highest value period for advertising associated with the query, since it may be the period during which such advertisement is likely to have the highest performance.

Although much of the description herein incorporates a keyword query context, it is to be kept in mind that any type of user activity may be utilized. Furthermore, embodiments that utilize techniques associated with keywords may be utilized in different ways for different activities. For example, embodiments of the invention extract or determine, by machine learning, clustering, aggregation, or otherwise, keywords associated with particular user activity, even if such activity does not include specifically identified keywords or keyword queries. It is to be understood that, herein, techniques utilizing user queries can generally also be applied in embodiments of the invention that do not utilized queries, but instead use determined, associated, or generated representative keywords.

For instance, some embodiments of the invention extract or determine keywords associated with content or applications associated with user activity, such as content of a Web page or pages being viewed or interacted with by a user.

Certain queries may be associatable with one or more time windows during which performance of one or more advertisements is predicted to be better than times outside the window. For instance, to within a certain threshold probability, it may be predicted that a user that enters the query “flat tire”, or a variation thereof, may be most likely to click through an advertisement relating to a towing service within a certain amount of time, say 2 hours, of entering the query. Other queries or groups of queries may be associatable with very different time windows. For example, the query “vacation package” may be associatable with a much longer time window, say perhaps a month. Furthermore, such time windows may not immediately follow entry of the query, such as a time window that may be considered to exist from, for example, two days to three weeks after a particular entry of a query.

Of course, temporal response profile generation according to embodiments of the invention can be based on more than one user activity, type of user activity, or circumstance or characteristic associated with user activity. This is true for embodiments of the invention that use user keyword queries, for instance.

In fact, in addition to such keyword queries, many different types of historical user activity information can be used in generating a temporal response profile. For instance, a device or context that a user is determined to be using at the time of entry of the query, or at another time, may be considered. For example, the query “flat tire repair” may be determined to be associated with a shorter ideal time window than the same query as entered through a personal computer. Many variations are possible, of course, including a user-associated device, platform, tactic, application, content, consumption of content, etc.

Another type of information that may be utilized, in addition to the keyword query, is historical action or conversion information associated with the user. For instance, with respect to a particular type of product, service, or content, a user may be categorized according to an associated present user conversion state, such as searched but not clicked, clicked but not converted, clicked and converted, etc. Each different type of activity or circumstance can itself be associated with a time window, or time windows, or cycles, including probabilistic representations of such windows. Furthermore, associated indexes may be generated and used in determining window, associated probabilities, etc., such as conversion indexes, user engagement indexes, etc. Mathematical, probabilistic, machine learning, or clustering techniques can be used in integrating or considering all such windows or cycles as an aspect of generation of a temporal response profile. Furthermore, such techniques, the temporal response profile, or both, may include, or include use of, probability distributions, such as distributions using mass functions, as well as other known sophisticated predictive, mathematical, statistical, probabilistic, stochastic, clustering and machine learning techniques.

Furthermore, as mentioned above, advertisements, and characteristics or circumstances associated with the advertisements can also be associated with time windows, cycles, etc. Matching of an advertisement to a temporal response profile at a particular time can be based on the temporal response profile as well as the time windows, cycle stage, etc. associated with the advertisement, such as a selling cycle phase.

Some embodiments of the invention provide methods and systems not only for optimized matching of advertisements to be served to particular users at particular times, but also to larger scale advertisement selection, allocation and time-sensitive serving that incorporates many instances of such optimized matching. Such methods and systems may optimize over time and changing circumstances, and over huge numbers of instances, advertisement campaigns, users, etc., and considering advertising inventory, serving opportunity inventory, advertising campaign parameters, and many other localized and global factors, include, of course, many types of targeting.

Some embodiments of the invention determine or utilize associations between keyword queries, or groups of keyword queries, and products or services. Timelines, time windows, cycles, or stages may be associated with such products or services, represented or mathematically modeled, and used as factors in generation of temporal response profiles. For example, some embodiments of the invention associate such products or services with time windows of various lengths. For instance, the query “flat tire repair” may be associated with a short time window, whereas “vacation plans” may be associated with a long time window, where the time windows may represent periods during which associated advertisements may be most likely to be effective, or may be predicted to be at or above a defined threshold of ideal or acceptable performance. Such time windows and lengths thereof may be used, in addition of course to many other factors, in optimizing associated advertising. Such other factors can include, for example, a selling cycle phase associated with an advertisement as well as a temporal response profile that reflects factors including a buying cycle phase associated with the user at a particular time. Of course, other types of targeting may also be included in associated advertisement selection, matching, serving, etc. Furthermore, while phases may be viewed or treated as discrete, smooth probabilistic functions may also or instead be utilized.

Some embodiments of the invention incorporate aspects of immediacy targeting in advertiser bidding and pricing associated with advertising, such as sponsored search advertising including advertising in connection with keyword phases and groups of phrases. In such contexts, an advertiser bid may indicate or influence an amount of money that the advertiser is willing to pay for an advertisement or listing in connection with a keyword query of a particular set. Bidding or pricing in connection with those and other forms of advertising may be adjusted or influenced by immediacy targeting-related factors. Many variations are possible. For example, a bid or price may be adjusted upward if an advertisement is served in a particular ideal time window, or particularly optimally in connection with a temporal response profile.

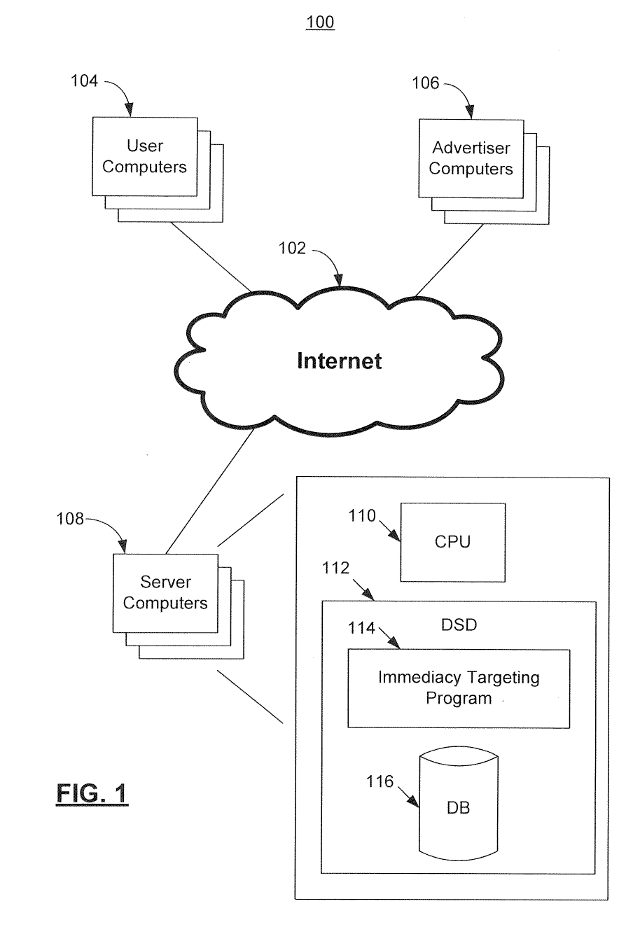

FIG. 1 is a distributed computer system 100 according to one embodiment of the invention. The system 100 includes user computers 104, advertiser computers 106 and server computers 108, all connected or connectable to the Internet 102. Although the Internet 102 is depicted, the invention contemplates other embodiments in which the Internet is not includes, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers 104, 106, 108 may be distributed, and can include various hardware, software, applications, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as keyword searching and advertising in a sponsored search context.

As depicted, each of the server computers 108 includes one or more CPUs 110 and a data storage device 112. The data storage device 112 includes a database 116 and an immediacy targeting program 114.

The immediacy targeting program 114 is intended to broadly include all programming, applications, software and other and tools necessary to implement or facilitate methods and systems according to embodiments of the invention, whether one a single server computer or distributed among multiple computers of devices.

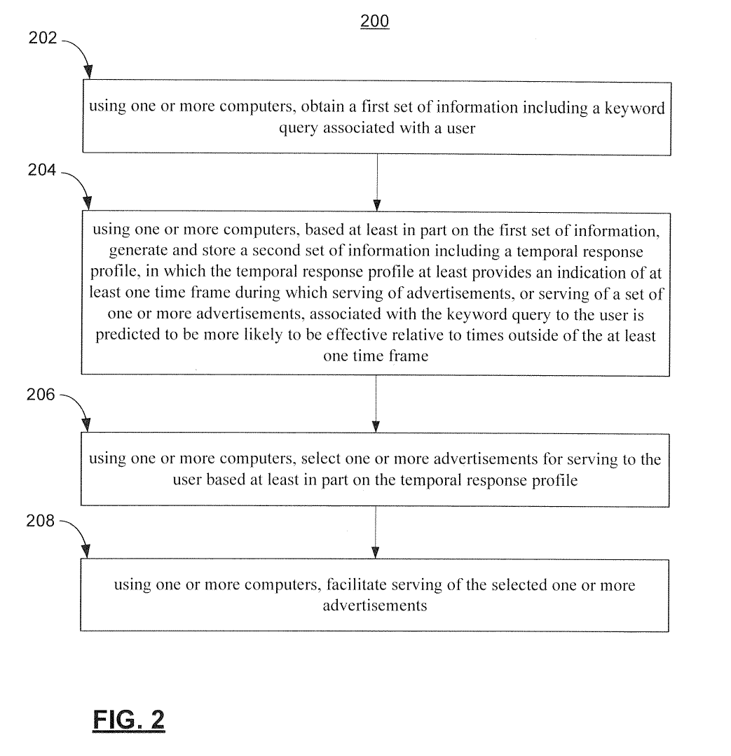

FIG. 2 is a flow diagram 200 of a method according to one embodiment of the invention, which may be implemented or facilitated, for example, using the immediacy targeting program 114 and the database 116. At step 202, using one or more computers, a first set of information is obtained, including a keyword query associated with a user.

At step 204, using one or more computers, based at least in part on the first set of information, a second set of information is obtained and stored including a temporal response profile, in which the temporal response profile at least provides an indication of at least one time frame during which serving of advertisements, or serving of a set of one or more advertisements, associated with the keyword query to the user is predicted to be more likely to be effective relative to times outside of the at least one time frame.

At step 206, using one or more computers, one or more advertisements are selected for serving to the user based at least in part on the temporal response profile.

Finally, at step 208, using one or more computers, serving of the selected one or more advertisements is facilitated.

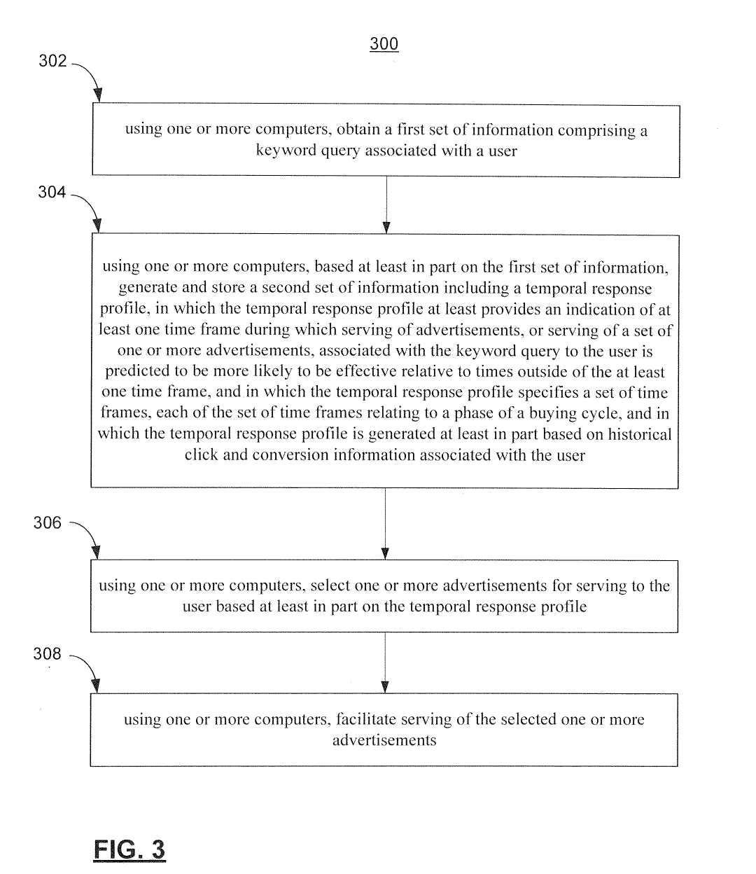

FIG. 3 is a flow diagram 300 of a method according to one embodiment of the invention which may be implemented or facilitated, for example, using the immediacy targeting program 114 and the database 116. Step 302 of the method 300 is similar to step 202 of the method 200 depicted in FIG. 2.

At step 304, using one or more computers, based at least in part on the first set of information, a second set of information is generated and stored including a temporal response profile. The temporal response profile at least provides an indication of at least one time frame during which serving of advertisements, or serving of a set of one or more advertisements, associated with the keyword query to the user is predicted to be more likely to be effective relative to times outside of the at least one time frame. The temporal response profile specifies a set of time frames, each of the set of time frames relating to a phase of a buying cycle. The temporal response profile is generated at least in part based on historical click and conversion information associated with the user.

Steps 306 and 308 of the method 300 are similar to steps 206 and 208 of the method 200 as depicted in FIG. 2.

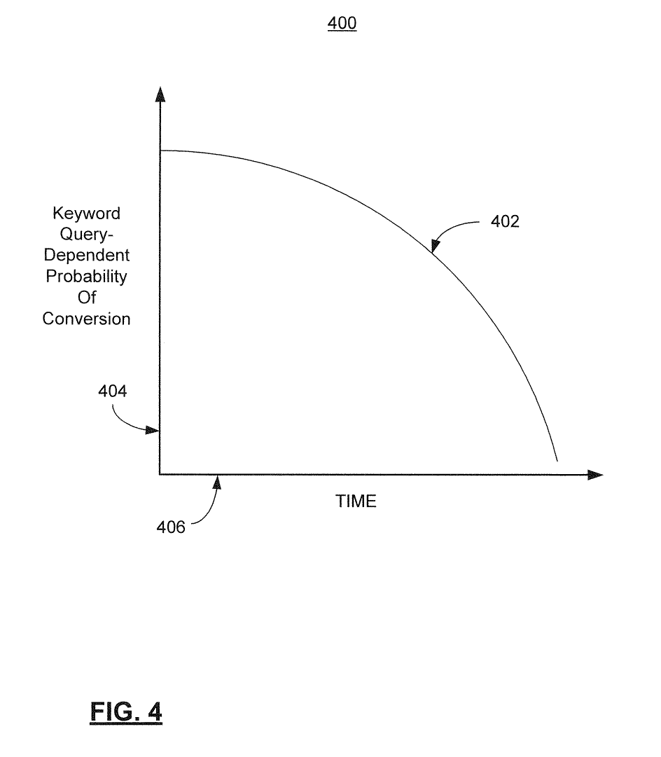

FIG. 4 is a graphical representation 400 of a keyword-dependent probability of click through over time, according to one embodiment of the invention. As depicted, the vertical axis 402 corresponds to keyword query-dependent probability of click through, and the horizontal axis 406 corresponds to time, as measured from entry of a keyword query. The curve 402 represents a hypothetical keyword query-dependent probability of click through over time, where the click through is in connection with an advertisement served at a particular time and in connection with the keyword query.

FIG. 4 is highly simplified, and particulars may vary, yet it illustrates an important principle that is utilized in some embodiments of the invention. Specifically, the hypothetical curve 402 indicates a probability of click through that is highest for a particular period of time; in this case, a period of time immediately following entry of the keyword query. As can be seen, the probability of click through associated with the advertisement declines over time. This, among other things, can be used in the selection, allocation and scheduling and prioritization of advertising in order to maximize the performance and value of such advertising.

Although FIG. 4 is associated with a keyword query, the principle applies to other forms of user activity that allow destination or prediction of such time-based advertisement performance. Furthermore, although probability of click through is depicted, other actions or measures of performance could apply instead, such as probability of a particular action, or of a conversion, for example.

The curve 402 illustrates a case that occurs for many keyword queries and groups of queries. Specifically, performance of advertising associated with the query remains high for a period of time, but declines over time. As such, it is possible in such cases to identify a time period during which performance is predicted to be, for example, above a certain threshold, such that at times after such time period, performance is predicted to be below the threshold. This can be a very important consideration, for example, in search re-targeting, where a predicted performance and value of an advertisement associated with the keyword query may be highly dependent on, among other things, how much time has passed between entry of the query by the user and serving of the advertisement to the user.

Embodiments of the invention include, among other things, determining such predicted performance time windows, and utilizing them in generating temporal response profiles.

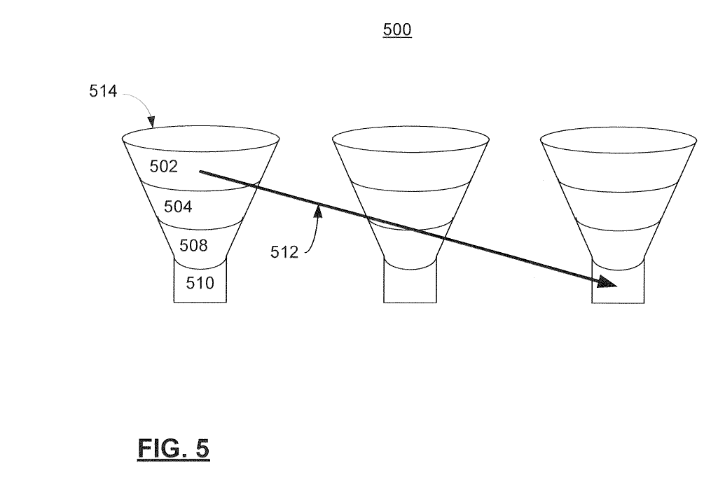

FIG. 5 is a block diagram 500 representing targeting of advertising based on a state of a user in a buying cycle. As mentioned generally above, often, a user's activity leading up to an action such as a conversion or a purchase can be divided into phases, which phases may relate to the intent or state of mind of the user, that can be helpful in determining or predicting advertising that is likely to be most effective for that stage. One way of defining and representing such phases includes depiction of what may be referred to as a conversion “funnel”. Block 514 represents a hypothetical conversion funnel. Generally, the width of the funnel 514 corresponds to a probability of conversion, while the position along the length, going downward, corresponds to increasing time.

Different funnels, including funnels with different phases, shapes, widths, lengths, etc. may be generated for different buying cycles, such as buying cycles associated with different products or services or types of products or services.

The funnel 514 may begin, for example, when a user enters a keyword query. Typically, users pass through a series of phases over time in connection with their intent relative to a product or service associated with the query. Such phases may be associated not only with different probabilities of conversion, but also with different susceptibility of the user to different types of advertisements. It should be noted that although discrete phases are depicted, probabilistic, functional, or other smooth curve representations may also be utilized.

As depicted, the funnel 514 includes phases including awareness 502, interest 504, desire 506, and action 508. The awareness phase 502 can include a user being aware of a certain opportunity, such as an opportunity to shop for and buy an item. An initial search query, or exposure to particular content, for example, may indicate the start of the awareness phase 502. The interest phase 504 can include, for example, the user further researching the opportunity. The desire phase 506 can include, for example, a time during which user activity indicates a desire to make a purchase or other conversion. The conversion phase 508 can indicate the user actually converting, such as making a purchase.

As represented by arrow 512, the user typically proceeds through these phases in order over time. Advertising associated with the pertinent opportunity may ideally be suited to the phase, which may be the phase of a buying cycle.

Different types of advertisements may be more likely to perform well at different phases of the buying cycle. For example, a “buy now!” advertisement might work well at the desire phase 506, but not at the awareness phase 502, while an informative advertisement might perform best at the awareness phase 502, etc.

In some embodiments, advertisements are selected based at least in part on a determined predicted phase of the user in the buying cycle, or with predicted time windows associated therewith, which may be reflected in a generated temporal response profile.

Furthermore, in some embodiments, advertisements are divided according to a pertinent phase in a determined selling cycle. Matching of an advertisement to a serving opportunity to a user at a particular time can include, among other things, ensuring that a selling cycle phase associated with the advertisement is a good match with a current, or predicted, user buying cycle phase. Of course, other factors, including other immediacy-related factors, may be involved.

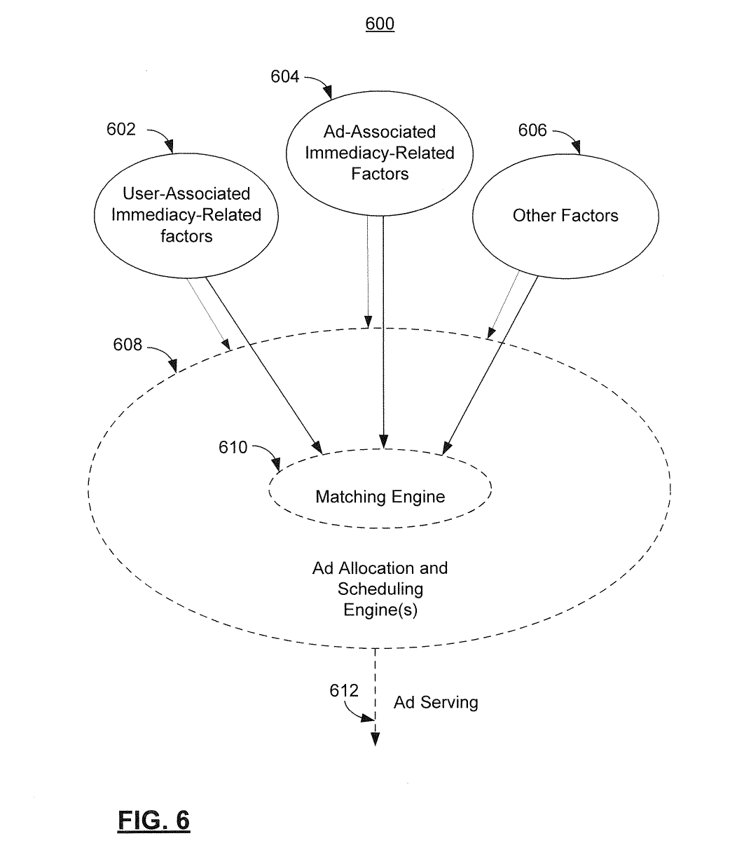

FIG. 6 is a conceptual block diagram representing an advertisement selection, scheduling and serving system 600, incorporating immediacy targeting, according to one embodiment of the invention. Blocks 602-606 represent types of information utilized in the system 600 as factors in influencing advertisement allocation, matching, scheduling, and serving. The factors include user-associated immediacy-related factors 602, advertisement-associated immediacy-related factors 604, and other factors 606. The other factors 606 may include other immediacy related factors as well as a variety of other factors, including time of serving, various targeting factors and types of targeting factors, bid and price factors, advertisement campaign budget and other parameter factors, serving opportunity inventory and advertisement inventory factors, contractual or agreement-related factors, and many other factors. The factors 602-606 are utilized by matching engine 610 and the larger advertisement and scheduling engine(s) 608, which in turn are used in facilitation of advertisement serving 612.

Block 602 broadly represents all user-associated immediacy-related factors provided in embodiments of the invention. For example, Block 602 can include use of one or more temporal response profiles. The temporal response profiles, as described herein, can utilize a variety of information including historical user activity information and determinations and predictions associated therewith, including platform, device, application, or content usage or consumption information, search query information, buying cycle and buying cycle phase information conversion information, etc., including time information associated therewith. Block 602 also includes information or models determined or predicted from such information, which may include the use of machine learning, for instance.

Block 604 broadly represents all advertisement-associated immediacy-related factors provided by embodiments of the invention. Such factors, as described above, can include selling cycles and selling cycle phases, the type of advertisement relative to selling cycle phases or buying cycle phases, timelines and time windows associated with the advertisements, etc. Block 604 also includes other advertisement-associated immediacy related factors, such as factors pertaining the associated advertisement campaign, advertiser, etc.

As depicted in FIG. 6, the matching engine 610 and the larger advertisement allocation and scheduling engines 610 which themselves can be or include embodiments of the invention, can make use of the factors 602-606.

The foregoing description is intended merely to be illustrative, and other embodiments are contemplated within the spirit of the invention.

What is claimed is:

1. A method comprising:
using one or more computers, obtaining a first set of information comprising a keyword query associated with a user;
using one or more computers, based at least in part on the first set of information, generating a second set of information comprising a temporal response profile;
wherein the temporal response profile at least provides an indication of at least one time frame during which serving of advertisements, or serving of a set of one or more advertisements, associated with the keyword query to the user is predicted to be more likely to be effective relative to times outside of the at least one time frame;
using one or more computers, storing the second set of information;
using one or more computers, selecting one or more advertisements for serving to the user based at least in part on the temporal response profile; and
using one or more computers, facilitating serving of the selected one or more advertisements.

2. The method of claim 1, comprising prioritizing and selecting the one or more advertisements for serving to the user based at least in part on the temporal profile.

3. The method of claim 1, comprising generating a temporal response profile that is based at least in part on anticipated performance of the one or more advertisements with regard to the user.

4. The method of claim 3, comprising generating a temporal response profile that facilitates immediacy-based targeting of a set of individual users based at least in part on historical information obtained for each of the set of individual users.

5. The method of claim 1, comprising facilitating serving of the selected one or more advertisements, wherein the advertisements are sponsored search advertisements.

6. The method of claim 1, comprising facilitating serving of the selected one or more advertisements, wherein the advertisements are sponsored search advertisements.

7. The method of claim 1, comprising facilitating serving of the selected one or more advertisements, wherein the advertisements are mobile advertisements.

8. The method of claim 1, comprising serving the one or more advertisements.

9. The method of claim 1, comprising generating a temporal response profile that specifies a set of time frames, each of the set of time flames relating to a phase of a buying cycle.

10. The method of claim 9, comprising selecting the one or more advertisements based at least in part on a determined match between the one or more advertisements and a time frame of the set of time frames of the temporal response profile, wherein the match relates at least in part to at least one time frame associated with the one or more advertisements during which the advertisements are predicted to be more likely to be effective relative to times outside the at least one time frame associated with the one or more advertisements.

11. The method of claim 10, comprising determining the set of time frames associated with the advertisement based at least in part on a selling cycle associated with the advertisement, and wherein the match relates at least in part to matching of a buying cycle phase with a selling cycle phase.

12. The method of claim 1, wherein facilitating serving of the selected one or more advertisements comprising facilitating search re-targeting.

13. The method of claim 1, comprising generating the temporal response profile based at least in part on historical click or conversion information associated with the user.

14. The method of claim 1, comprising selecting, allocating and scheduling serving of advertisements to users based at least in part on optimization with respect to targeting based at least in part on temporal response profiles.

15. A system comprising:
one or more server computers connected to the Internet; and
one or more databases connected to the one or more server computers;
wherein the one or more server computers are for:
obtaining a first set of information comprising a keyword query associated with a user;
based at least in part on the first set of information, generating a second set of information comprising a temporal response profile;
wherein the temporal response profile at least provides an indication of at least one time frame during which serving of advertisements, or serving of a set of one or more advertisements, associated with the keyword query to the user is predicted to be more likely to be effective relative to times outside of the at least one time frame;
storing the second set of information in at least one of the one or more databases;
selecting one or more advertisements for serving to the user based at least in part on the temporal response profile; and
facilitating serving of the selected one or more advertisements.

16. The system of claim 15, comprising serving of the selected one or more advertisements.

17. The system of claim 15, comprising utilizing a probabilistic model in generating the temporal response profile.

18. The system of claim 15, comprising using a machine learning technique in generating the temporal response profile or selecting the one or more advertisements.

19. The system of claim 15, comprising using historical click information associated with the user, in generating the temporal response profile.

20. A computer readable medium or media containing instructions for executing a method, the method comprising:
using one or more computers, obtaining a first set of information comprising a keyword query associated with a user;
using one or more computers, based at least in part on the first set of information, generating a second set of information comprising a temporal response profile;
wherein the temporal response profile at least provides an indication of at least one time frame during which serving of advertisements, or serving of a set of one or more advertisements, associated with the keyword query to the user is predicted to be more likely to be effective relative to times outside of the at least one time frame;
wherein the temporal response profile specifies a set of time frames, each of the set of time frames relating to a phase of a determined buying cycle; and
wherein the temporal response profile is generated at least in part based on historical click and conversion information associated with the user.
using one or more computers, storing the second set of information;
using one or more computers, selecting one or more advertisements for serving to the user based at least in part on the temporal response profile; and
facilitating serving of the selected one or more advertisements.
